(19) United States
(12) Patent Application Publication
(10) Pub. No.: US 2026/0353448 A1
(43) Pub. Date: Nov. 5, 2026

(54) TRANSMISSION RECEPTION POINT ADAPTATION

(71) Applicant: Nokia Technologies Oy, Espoo (FI)

(72) Inventors: Matha DEGHEL, Massy (FR); Daniela LASELVA, Aalborg (DK); Naizheng ZHENG, Beijing (CN)

(21) Appl. No.: 19/101,752

(22) PCT Filed: Aug. 12, 2022
(86) PCT No.: PCT/CN2022/112251

§ 371 Date: Feb. 6, 2025

(51) Int. Cl. H04W 74/0816; H04L 1/1607; H04W 74/00; H04W 80/02

(52) U.S. Cl. CPC H04W 74/0816; H04L 1/1614; H04W 74/006; H04W 80/02

(57) ABSTRACT

Embodiments of the present disclosure relate to transmission reception point (TRP) adaptation for network energy efficiency. A first device receives, from a second device, configuration information of at least one cell or at least one cell group for the first device. The configuration information indicates muting status of at least one TRP for the at least one cell or the at least one cell group. The first device determines, based on the configuration information, the muting status of the at least one TRP for the at least one cell or the at least one cell group. In this way, with the muting status of TRP(s) being indicated, a terminal device can operate accordingly to enable the dynamic TRP adaptation for energy savings.

### FIELD

Various example embodiments relate to the field of telecommunication and in particular, to methods, devices, apparatuses and a computer readable storage medium for transmission reception point (TRP) adaptation.

### BACKGROUND

In communication area, radio access network consumes the largest part of total energy consumption in a network and thus adaptation techniques of transmissions and/or receptions in time, frequency, spatial, and power domains are important for energy savings.

In Rel-18, it is agreed to utilize dynamic TRP adaptation for network energy savings. Thus enabling and/or facilitating of the dynamic TRP adaptation needs to be further studied.

### SUMMARY

In general, example embodiments of the present disclosure provide a solution for TRP adaptation for network energy efficiency.

In a first aspect, there is provided a first device. The first device comprises at least one processor and at least one memory storing instructions that, when executed by the at least one processor, cause the first device at least to: receive, at a first device and from a second device, configuration information of at least one cell or at least one cell group for the first device, the configuration information indicating muting status of at least one transmission reception point (TRP) for the at least one cell or the at least one cell group; and determine, based on the configuration information, the muting status of the at least one TRP for the at least one cell or the at least one cell group.

In a second aspect, there is provided a second device. The second device comprises at least one processor; and at least one memory storing instructions that, when executed by the at least one processor, cause the first device at least to: determine, at a second device, configuration information of at least one cell or at least one cell group for a first device, the configuration information indicating muting status of at least one transmission reception point (TRP) for the at least one cell or the at least one cell group; and transmit the configuration information to the first device.

In a third aspect, there is provided a method. The method comprises receiving, at a first device and from a second device, configuration information of at least one cell or at least one cell group for the first device, the configuration information indicating muting status of at least one transmission reception point (TRP) for the at least one cell or the at least one cell group; and determining, based on the configuration information, the muting status of the at least one TRP for the at least one cell or the at least one cell group.

In a fourth aspect, there is provided a method. The method comprises determining, at a second device, configuration information of at least one cell or at least one cell group for a first device, the configuration information indicating muting status of at least one transmission reception point (TRP) for the at least one cell or the at least one cell group; and transmitting the configuration information to the first device.

In a fifth aspect, there is provided an apparatus comprising: means for receiving, at a first device and from a second device, configuration information of at least one cell or at least one cell group for the first device, the configuration information indicating muting status of at least one transmission reception point (TRP) for the at least one cell or the at least one cell group; and means for determining, based on the configuration information, the muting status of the at least one TRP for the at least one cell or the at least one cell group.

In a sixth aspect, there is provided an apparatus comprising: means for determining, at a second device, configuration information of at least one cell or at least one cell group for a first device, the configuration information indicating muting status of at least one transmission reception point (TRP) for the at least one cell or the at least one cell group; and means for transmitting the configuration information to the first device.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to: receive, at a first device and from a second device, configuration information of at least one cell or at least one cell group for the first device, the configuration information indicating muting status of at least one transmission reception point (TRP) for the at least one cell or the at least one cell group; and determine, based on the configuration information, the muting status of the at least one TRP for the at least one cell or the at least one cell group.

In a ninth aspect, there is provided a computer program comprising instructions, which, when executed by an apparatus, cause the apparatus at least to: determine, at a second device, configuration information of at least one cell or at least one cell group for a first device, the configuration information indicating muting status of at least one transmission reception point (TRP) for the at least one cell or the at least one cell group; and transmit the configuration information to the first device.

In a tenth aspect, there is provided a first device comprising: receiving circuitry configured to receive, at the first device and from a second device, configuration information of at least one cell or at least one cell group for the first device, the configuration information indicating muting status of at least one transmission reception point (TRP) for the at least one cell or the at least one cell group; and determining circuitry configured to determine, based on the configuration information, the muting status of the at least one TRP for the at least one cell or the at least one cell group.

In an eleventh aspect, there is provided a second device comprising: determining circuitry configured to determine, at the second device, configuration information of at least one cell or at least one cell group for a first device, the configuration information indicating muting status of at least one transmission reception point (TRP) for the at least one cell or the at least one cell group; and transmitting circuitry configured to transmit the configuration information to the first device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates an example of a process for enabling of the dynamic TRP adaptation according to some embodiments of the present disclosure;

FIG. 3 illustrates an example of a group common DCI containing the configuration information according to some embodiments of the present disclosure;

FIG. 4 illustrates another example of a process for enabling of the dynamic TRP adaptation according to some embodiments of the present disclosure;

FIG. 5 illustrates a flowchart of a method implemented at a terminal device according to some embodiments of the present disclosure;

FIG. 6 illustrates a flowchart of a method implemented at a network device according to some embodiments of the present disclosure;

FIG. 7 illustrates a simplified block diagram of an apparatus that is suitable for implementing embodiments of the present disclosure; and

FIG. 8 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “TRP” refers to a transmission reception point having an antenna array (with one or more antenna elements) at the network side located at a specific geographical location, which may be used for transmitting and receiving signals to/from the terminal device. In embodiment of the present disclosure, a TRP may refer to Macro Cell, micro cell, an RRH, a relay, a femto node, a pico node, etc. Although some embodiments of the present disclosure are described with reference to two TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As mentioned above, the enabling and/or facilitating of the dynamic TRP adaptation needs to be further studied. Specifically, a terminal device may need to know whether TRP(s) configured for the terminal device is muted or unmuted, thereby having a common understanding with the network to enable the dynamic TRP adaptation. However, currently there is no such mechanism proposed for this purpose.

According to embodiments of the present disclosure, there is providing a solution for enabling or facilitating of the dynamic TRP adaptation. In this solution, a first device, i.e., a terminal device receives, from a second device, i.e., a network device, configuration information of at least one cell or at least one cell group for the first device. The configuration information indicates muting status of at least one TRP for the at least one cell or the at least one cell group. Based on the configuration information, the first device determines the muting status of the at least one TRP for the at least one cell or the at least one cell group. As such, a terminal device can be aware of the muting status of TRP(s) configured for the terminal device, thus the terminal device may operate accordingly to enable the dynamic TRP adaptation.

Principle and embodiments of the present disclosure will be described in detail below with reference to the accompanying drawings. However, it is to be noted that these embodiments are illustrated as examples and not intended to limit scope of the present application in any way.

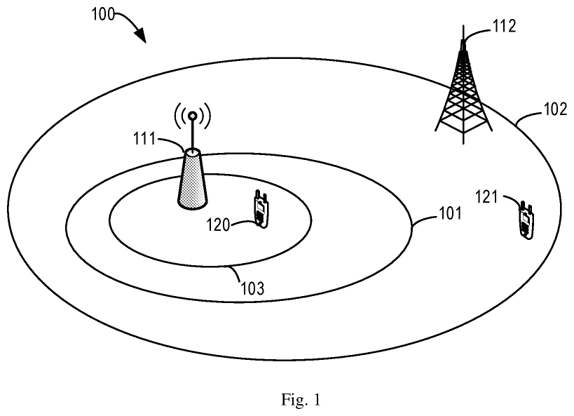

Reference is first made to FIG. 1, which illustrates an example communication system 100 in which embodiments of the present disclosure may be implemented. As illustrated in FIG. 1, the system 100 includes two network devices, such as network device 111 and network device 112. The network devices 111 and 112 may each have one respective group of antenna ports. In other words, the network devices 111 and 112 may be associated with or function as two respective TRPs, and thus can be also referred to as TRP 111 and TRP 112 in the present disclosure.

The network devices 111 and 112 may each serve one or more areas (also referred to as cells) using different frequency bands in both DL and UL. In communication systems, “UL” refers to a communication link in a direction from a terminal device to a network device, and “DL” refers to a communication link in a direction from the network device to the terminal device.

The system 100 also includes one or more terminal devices, such as terminal devices 120 and 121. The terminal devices 120 and 121 are capable of connecting and communicating in an UL and DL with either or both of the network devices 111 and 112 depending on location of the terminal devices in the cells of the network devices 111 and 112.

As shown in FIG. 1, for example, the network device 111 may serve cells 101, 102 and 103 and the network device 112 may serve the cell 102. The cells 101, 102 and 103 may be configured as serving cells for a terminal device 120. The cell 102 may be configured as a serving cell for a terminal device 121.

Moreover, although it is not shown in FIG. 1, the cells 101, 102 and 103 may be grouped into one or more cell groups for the terminal device 120 depending on a certain grouping rule. For example, the cells 101, 102 and 103 may be grouped for purpose of TRP muting or unmuting. As an example, the cells 101, 102 and 103 may be determined as one cell group. As another example, the cells 101 and 102 may be determined as a first cell group and the cell 103 may be determined as a second cell group.

It is to be understood that in FIG. 1, the number of network devices (TRPs) and terminal devices is only for the purpose of illustration without suggesting any limitations. The system 100 may include any suitable number of network devices (TRPs) and terminal devices adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

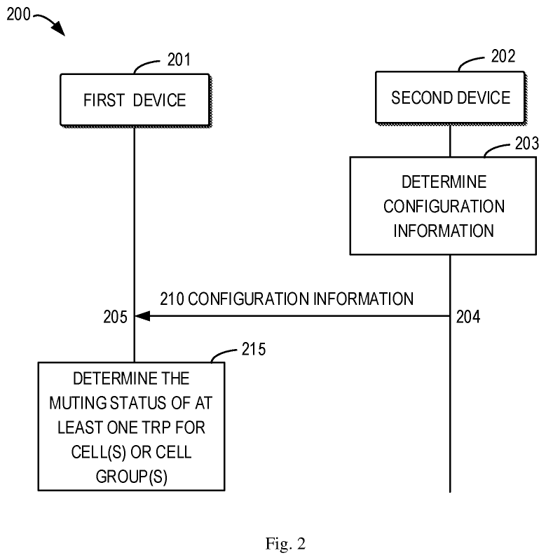

Reference is now made to FIG. 2, which shows an example of a process 200 for enabling of the dynamic TRP adaptation according to an embodiment of the present disclosure. For the purpose of discussion, the process 200 will be described with reference to FIG. 1.

A first device 201 and a second device 202 may be involved in the process 200. The first device 201 may be a terminal device, e.g., the terminal device 120 or terminal device 121 as shown in FIG. 1. The second device 202 may be a network device, e.g., the network device 111, network device 112 as shown in FIG. 1 or another network device communicating with the first device 201.

In the process 200, the second device 202 determines 203 configuration information of at least one cell or at least one cell group for the first device 201. The configuration information indicates muting status of at least one TRP for the at least one cell or the at least one cell group for the first device 201.

The second device 202 may determine whether to mute or unmute TRP(s) configured for the first device 201 for energy savings, i.e., the second device 202 may determine the dynamic TRP adaptation for the first device 201.

The second device 202 transmits 204 the determined configuration information 210 to the first device 201. The first device 201 receives 205 the configuration information 210 from the second device 202. As an example, the terminal device 120 may receive configuration information 210 from the network device 111 and/or network device 112. Based on the configuration information 210, the first device 201 determines 215 the muting status of at least one TRP for the at least one cell or the at least one cell group.

In some embodiments, the configuration information 210 may be specific to a cell or a cell group, where the cell or a cell in the cell group may be a serving cell (or even a non-serving cell, which is configured with a PCI different than serving cell PCI), for the first device 201. As an example, the terminal device 120 may receive the configuration information 210 indicating the muting status of the TRP 111 for the one cell 101. As another example, the terminal device 120 may receive the configuration information 210 indicating the muting status of TRPs 111 and 112 for a cell group comprising the cells 101 and 102.

In some embodiments, the configuration information 210 may be specific to multiple cells or multiple cell groups. As an example, the terminal device 120 may receive the configuration information 210 indicating the muting status of the TRP 111 for the cell 101 and the muting status of the TRPs 111 and 112 for the cell 102 at the same time. As another example, the terminal device 120 may receive the configuration information 210 indicating the muting status of TRPs for a first cell group comprising the cells 101 and 102 and the muting status of the TRP 111 for a second cell group comprising the cell 103.

In some embodiments, the first device 201 may receive 205 the configuration information 210 via a medium access control (MAC) control element (CE). Alternatively or in addition, the first device 201 may receive 205 the configuration information 210 via a radio resource control (RRC) message. Alternatively or in addition, the first device 201 may receive 205 the configuration information 210 via downlink control information (DCI). The DCI may be a user-specific DCI. In other words, the first device 201 may receive 205 the configuration information 201 via a DCI specific to the first device 201. Alternatively, the DCI may be a group common DCI destined to a group of devices comprising the first device 201. The group common DCI may contain the configuration information 210.

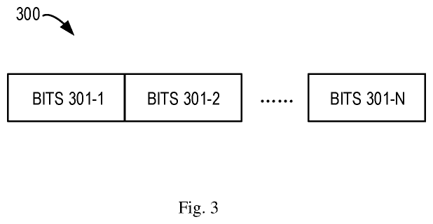

FIG. 3 illustrates an example of a group common DCI 300 containing the configuration information 210 according to an embodiment of the present disclosure. As shown in FIG. 3, the group common DCI 300 may have a set of bits or fields specific to each of the group of devices. In other words, each set of bits or fields may be used for indicating the configuration information for the respective terminal device. For example, a first set of bits 301-1 may be used for indicating the configuration information for the terminal device 120, and a second set of bits 301-2 may be used for indicating the configuration information for the terminal device 121. The group common DCI 300 may have other sets of bits, e.g., a set of bits 301-N.

In some embodiments, the first set of bits 301-1 may be the same as the second set of bits 301-2, thus the configuration information indicated by the first set of bits 301-1 may be the same as the configuration information indicated by the second set of bits 301-2. Alternatively, the configuration information indicated by the first set of bits 301-1 may be different from the configuration information indicated by the second set of bits 301-2.

Referring back to FIG. 2, in some embodiments, the first device 201 may receive 205 the configuration information 210 by receiving a bitmap. The configuration information 210 may be or may be indicated by the bitmap. A value of a bit may indicate the muting status of a TRP, e.g., whether a TRP is muted or unmuted. The number of bits in the bitmap may depend on the number of cells or cell groups configured for the first device 201 for the purpose of enabling the dynamic TRP adaptation. Alternatively or in addition, the number of bits may depend on the number of TRP(s) configured for each cell or cell group.

The bitmap may comprise at least one bit associated with or specific to a cell or a cell group configured for the first device 201 for the purpose of enabling the dynamic TRP adaptation. For example, the bitmap may comprise bits [1 0] corresponding to a cell configured with two TRPs. The first bit value 1 may indicate that the first TRP is unmuted and the second bit value 0 may indicate that the second TRP is muted, or vice versa.

In some embodiments, a primary TRP and a secondary TRP may be configured for a cell. In this case, the bitmap may comprise one bit indicating the muting status of the secondary TRP for the cell without a bit indicating the muting status of the primary TRP for the cell. In other words, only one TRP may be allowed to be dynamically muted. As such, the number of bits required to indicate the muting status of TRP(s) may be reduced. For example, if a cell is configured with TRP 0 and TRP 1 and TRP 0 is configured as the secondary TRP, the bitmap may comprise one bit [0] to indicate that the TRP 0 is muted.

In some embodiments, the bitmap may comprise a first bit indicating the muting status of a first TRP for a cell group and a second bit indicating the muting status of a second TRP for the cell group.

In some embodiments, a first cell and a second cell of the cell group may be both configured with the first TRP and the second TRP. In this case, the first bit value 1 may indicate that the first TRP is unmuted and the second bit value 0 may indicate that the second TRP is muted for both of the first cell and the second cell.

For example, the bitmap may comprise bits [1 0] corresponding to the cell group comprising the first cell and the second cell. The first bit value 1 may indicate that the first TRP is unmuted for the cell group and the second bit value 0 may indicate that the second TRP is muted for the cell group.

In some other embodiments, a first cell of a cell group may be configured with multiple TRPs (such as two TRPs, e.g. through the configuration of two CORESETPoolIndex) and a second cell of the cell group may be configured with a single TRP (e.g., no multi-TRP configuration provided for that cell). In this case, a default TRP or TRP identifier may be assumed or configured for the second cell, e.g., a TRP corresponding to a lower or higher index of a TRP identifier (such as CORESETPoolIndex 0). Thus the muting status of the single TRP may be indicated by a certain bit (by default).

For example, the bitmap may comprise bits [1 0] corresponding to a cell group comprising the first cell and the second cell. The first cell may be configured with TRP 0 and TRP 1, and the second cell may be configured with (a default) TRP 0. In this case, the first bit value 1 may indicate that the TRP O is unmuted and the second bit value 0 may indicate that the second TRP1 is muted.

In some embodiments, the bitmap may comprise sets of bits and each set of bits corresponds to a cell or a cell group. For example, the bitmap may comprise bits [1 0 1 1] corresponding to a first cell/cell group and a second cell/cell group. The first two bits [1 0] may correspond to the first cell/cell group and the second two bits [1 1] may correspond to the second cell/cell group.

In some embodiments, alternative or in addition to the bitmap, the first device 201 may receive 205 the configuration information 210 by receiving an indicator associated with a muting pattern of at least one muting pattern. The first device 201 may be configured (e.g., via a radio resource control (RRC) configuration) with the at least one muting pattern and each muting pattern may indicate the muting status of at least one TRP for a cell or a cell group.

The indicator may be an index of the muting pattern. Alternatively, the indicator may be a bitmap corresponding to a muting pattern. The indicator may be contained in a DCI or a MAC CE (or even RRC). The first device 201 may receive the indicator via a DCI or a MAC CE (or even RRC) and then apply the muting pattern associated with the indicator to a corresponding cell or cell group.

In some embodiment, the muting pattern may further indicate a muting cycle (or referred to as a muting time-period) and/or an unmuting cycle (or referred to as an unmuting time-period). In other words, the muting pattern may indicate a periodic or recurrent TRP muting/unmuting cycle. One or more TRPs may be muted during the muting cycle (or the muting time-period) and become unmuted after the muting cycle (or the muting time-period). Alternatively or in addition, the one or more TRPs may be unmuted during the unmuting cycle (or the unmuting time-period) and become muted after the unmuting cycle (or the unmuting time-period).

Moreover, the muting cycle and/or the unmuting cycle may be configured for one TRP or multiple TRPs. In other words, the muting cycle may comprise a set of sub-cycles for a set of TRPs. For example, the muting cycle may comprise a first sub-cycle and a second sub-cycle. A first TRP may be muted during the first sub-cycle and a second TRP (or both of the first and second TRP) may be muted during the second sub-cycle.

In some embodiments, the first device 201 may determine that the configuration information 210 is received based on a dedicated radio network temporary identifier (RNTI) scrambling a DCI. The dedicated RNTI may be a new RNTI or an existing RNTI. The first device 201 may be pre-configured with a set of RNTIs. A dedicated RNTI of the set of RNTIs may indicate that the scrambled DCI contains the configuration information 210.

Alternatively or in addition, the first device 201 may determine that the configuration information 210 is received based on at least one dedicated control resource set (CORESET). The at least one dedicated control resource set (CORESET) may be configured or indicated to be used to send a physical downlink control channel (PDCCH) carrying the DCI containing the configuration information 210. Similarly, the first device 201 may be pre-configured with an association between the at least one dedicated CORESET and the configuration information 210.

Alternatively or in addition, the first device 201 may determine that the configuration information 210 is received based on at least one dedicated field or bit in a DCI or a MAC CE. The at least one dedicated field or bit may be newly defined or existing field(s) or bit(s). Similarly, the first device 201 may be pre-configured with an association between the at least one dedicated field or bit and the configuration information 210.

Alternatively or in addition, the first device 201 may determine that the configuration information 210 is received based on a dedicated DCI format. The dedicated DCI format may be an existing DCI format, e.g., DCI format 0_1 or 0_2 used for scheduling a UL transmission, DCI format 1_1 or 1_2 used for scheduling a DL transmission, or a group common DCI format such as DCI format 2_6. Alternatively, the dedicated DCI format may be a new DCI format for the purpose of enabling dynamic TRP adaptation.

Alternatively or in addition, the first device 201 may determine that the configuration information 210 is received based on a bitmap indicating the configuration information 210. The first device 201 may receive the bitmap and determine that the configuration information 210 is received.

In some embodiments, the first device 201 may receive an indication or a configuration, via an RRC, a MAC CE or a DCI, or hardcoded in specifications, from the second device 202. Based on the indication or configuration, the first device 201 may determine that the configuration information 210 is received. As mentioned above, the first device 201 may receive the configuration information 210 via a DCI or a MAC CE (or even RRC). When receiving a DCI or a MAC CE, the first device 201 may determine that the DCI or the MAC CE contains the configuration information 210 based on the indication or the configuration and then determine the muting status of TRP(s) from the configuration information 210.

In some embodiments, the indication or the configuration may be a dedicated radio network temporary identifier (RNTI) scrambling a DCI. The dedicated RNTI may be a new RNTI or an existing RNTI. The first device 201 may be pre-configured with a set of RNTIs. A dedicated RNTI of the set of RNTIs may indicate that the scrambled DCI contains the configuration information 210.

Alternatively or in addition, the indication or the configuration may be a dedicated DCI format. The dedicated DCI format may be an existing DCI format, e.g., DCI format 0_1 or 0_2 used for scheduling a UL transmission, DCI format 1_1 or 1_2 used for scheduling a DL transmission, or a group common DCI format such as DCI format 2_6. Alternatively, the dedicated DCI format may be a new DCI format for the purpose of enabling dynamic TRP adaptation.

Alternatively or in addition, the indication or the configuration may be part of a bitmap indicating the configuration information 210. The first device 201 may receive the bitmap and determine that the configuration information 210 is received. In other words, the bitmap may indicate that the configuration information 210 is carried and also indicate the configuration information 210 itself.

Note that, in some embodiments, the configuration information 210 indicating the muting status of TRP(s) may be implemented by reusing an indicator of bandwidth part (BWP) dormancy information and/or wake-up information for the first device 201. For example, the DCI format 2_6 or an existing bitmap currently used for indicating the wake-up information and/or the BWP dormancy information may be reused as or may be reused for indicating the configuration information 210.

Moreover, in some embodiments, the cells may be grouped for the purpose of enabling dynamic TRP adaptation based on a grouping rule for the purpose of BWP dormancy. In other words, the configuration information 210 may be specific to a cell group that is the same as a cell group configured for BWP dormancy or cell dormancy.

In some embodiments, the configuration information 210 may indicate both of the muting status of TRP(s) and the BWP dormancy information (or the wake-up information). For example, a bit in the bitmap may indicate both of the muting status of a TRP and the BWP dormancy. As another example, the existing bitmap for the BWP dormancy information may be extended in size to accommodate the required bits for indicating the muting status of TRP(s).

In this case, when receiving a DCI or a MAC CE, the first device 201 may first determine, based on the indication or the configuration, whether the DCI or the MAC CE contains the configuration information 210 indicating one of the muting status, the BWP dormancy information or the wake-up information. The first device 201 may further determine the muting status of TRP(s) from the configuration information 210 based on a pre-configured association between the configuration information 210 and interpretation of the configuration information 210 by the first device 201.

Alternatively, when receiving a DCI or a MAC CE, the first device 201 may determine, based on the indication or the configuration, that the DCI or the MAC CE contains the configuration information 210 and also determine the muting status of TRP(s) from the configuration information 210 based on the indication or the configuration. For example, the first device 201 may determine, based on a dedicated RNTI, that a scrambled DCI contains the configuration information 210 and determine the muting status of TRP(s).

Based on the configuration information 210, the first device 201 determines 215 the muting status of the at least one TRP for the at least one cell or the at least one cell group for the first device 201.

In some embodiments, the first device 201 may determine, for a TRP (e.g., each TRP) of the at least one TRP, the muting status as one of a set of status. The set of status may comprise a first status in which all transmissions and receptions between the first device 201 and the TRP are muted. The first status may be also referred to as full-muting status.

Alternatively or in addition, the set of status may comprise a second status in which at least one predetermined transmission or reception between the first device 201 and the TRP is muted. The predetermined transmission(s) or reception(s) to be muted in the second status may be defined in specifications. Alternatively, the predetermined transmission(s) or reception(s) to be muted may be provided to the first device 201 via an RRC configuration. The second status may be also referred to as partial-muting status. The partial muting status may be seen as some sort of TRP dormancy.

For example, if a TRP is in the partial-muting status, the first device 201 may not expect a PDCCH to be transmitted from the TRP. In this case, the first device 201 may not monitor the PDCCH. As another example, the first device 201 may not expect any receptions from this TRP.

Alternatively or in addition, the set of status may comprise a third status in which no transmission or reception between the first device and the TRP is muted. In other words, the first device 201 may expect normal transmissions/receptions from/to the TRP. The third status may be also referred to as unmuted status.

In some embodiments, the first device 201 may be configured or indicated (e.g., via a RRC or a MAC CE) whether full muting status or partial muting status should be considered when determining the muting status. Alternatively, the first device 201 may be indicated whether full muting status or partial muting status should be considered via a DCI or a MAC CE using new or existing field(s), bit(s) or format(s).

In some embodiments, a periodicity of a predetermined transmission or reception in the second status may be different from a corresponding periodicity of the predetermined transmission or reception in the third status. The predetermined transmission or reception may be a transmission/reception that is unmuted in the partial muting status, but the periodicity of the transmission/reception may be longer than the periodicity as in the unmuted status. As such, better energy savings can be achieved.

In some embodiments, the first device 201 may determine, for the TRP of the at least one TRP, the muting status for a BWP of a cell configured with the TRP. In other words, the muting status may be configured on a BWP level rather than being configured for a full bandwidth of the cell.

In some embodiments, a TRP may be identified by a CORESETPoolIndex. Alternatively or in addition, a TRP may be identified by an identity of a TRP, e.g., TRP ID. Alternatively or in addition, a TRP may be identified by a set of reference signals (RSs). Alternatively or in addition, a TRP may be identified by a set of RS resources. Alternatively or in addition, a TRP may be identified by a physical cell ID (PCI).

In this way, through the process 200, the muting status of TRP(s) configured for the first device 201, e.g., the terminal device 120 can be indicated to the first device 201. Thus the first device 201 can operate in accordance with the muting status of the TRP(s), thereby enabling the dynamic TRP adaptation.

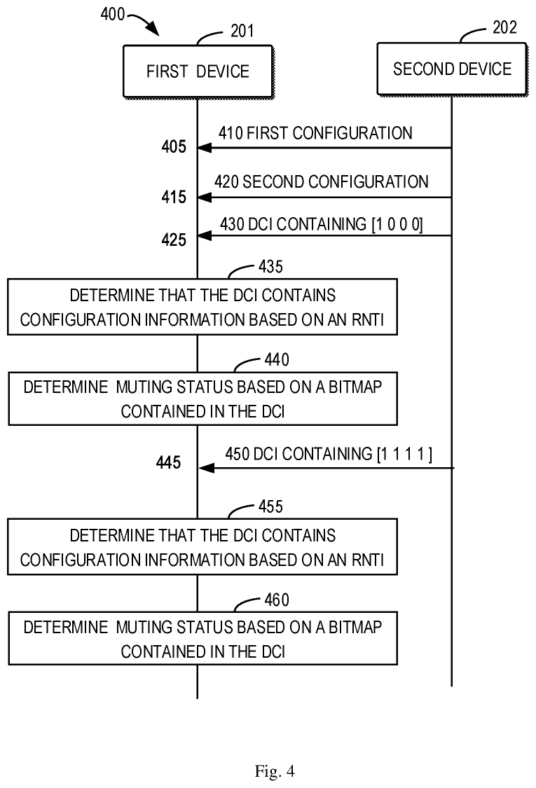

FIG. 4 illustrates another example of a process 400 for enabling of the dynamic TRP adaptation according to an embodiment of the present disclosure. It is noted that the process 400 can be deemed as a more specific example of the process 200. It would be appreciated that the process 400 may be applied to the communication system 100 of FIG. 1 and any other similar communication scenarios.

As shown in FIG. 4, the first device 201 may receive 405 a first configuration 410 comprising a set of RNTIs. Each RNTI may be used for indicating whether a scrambled DCI contains information for one or more of the muting status of TRP(s), the BWP dormancy information, or the wake-up information (or other information). For example, a first RNTI may indicate that a corresponding DCI contains information for the muting status of TRP(s), a second RNTI may indicate that a corresponding DCI contains information for the BWP dormancy information, and a third RNTI may indicate that a corresponding DCI contains information for both of the muting status of TRP(s) and the BWP dormancy information

The first device 201 may further receive 415 a second configuration 420 for configuring cell groups for the purpose of enabling dynamic TRP adaptation. The second configuration 420 may indicate configuring a first cell group (also referred to as cell group 0) and a second cell group (also referred to as cell group 1) for the first device 201.

The first device 201 may receive 425 a DCI 430 scrambled with a RNTI (e.g., the first RNTI or the third RNTI) used for indicating that the DCI 430 contains information for the muting status of TRP(s). The DCI 430 may contain a bitmap such as for example [1 0 0 0].

The first device 201 may determine 435, based on the RNTI scrambling the DCI 430, that the DCI 430 contains information for the muting status of TRP(s). The first device 201 may further determine 440, based on the bitmap contained in the DCI 430, the muting status of TRP(s) in the first cell group and the second cell group.

As an example, based on the bitmap [1 0 0 0], the first device 201 may determine 440 that the first two bits [1 0] correspond to the cell group 0 and the second two bits [0 0] correspond to the cell group 1, with the bit value 0 indicating muting of a TRP and bit value 1 indicating unmuting of a TRP. The first device 201 may determine 440 that a first TRP (e.g., TRP 0) may be unmuted for cell group 0 and muted for the cell group 1. The first device 201 may determine 440 that a second TRP (e.g., TRP 1) may be muted for both cell group 0 and cell group 1.

Similarly, the first device 201 may receive 445 a DCI 450 scrambled with a RNTI (e.g., the first RNTI or the third RNTI) used for indicating that the DCI 450 contains information for the muting status of TRP(s). The DCI 450 may contain a bitmap [1 1 1 1].

The first device 201 may determine 455, based on the RNTI scrambling the DCI 450, that the DCI 450 contains information for the muting status of TRP(s). The first device 201 may further determine 460, based on the bitmap contained in the DCI 450, the muting status of TRPs in the first cell group and the second cell group.

As an example, based on the bitmap [1 1 1 1], the first device 201 may determine 460 that the first two bits [1 1] correspond to the cell group 0 and the second two bits [1 1] correspond to the cell group 1, with the bit value 1 indicating unmuting of a TRP and bit value 0 indicating muting of a TRP. The first device 201 may determine 460 that TRP 0 may be unmuted for the cell group 0 and unmuted for the cell group 1. The first device 201 may determine 460 that the TRP 1 may be unmuted for both cell group 0 and cell group 1.

It is to be noted that, although it is not shown in FIG. 4, if the TRP 0 is configured for the cell group 1 and not configured for the cell group 0, the first device 201 may determine, based on the bitmap [1 1 1 1], that the TRP 0 may be unmuted for cell group 1. The first device 201 may determine that the TRP 1 may be unmuted for both cell group 0 and cell group 1.

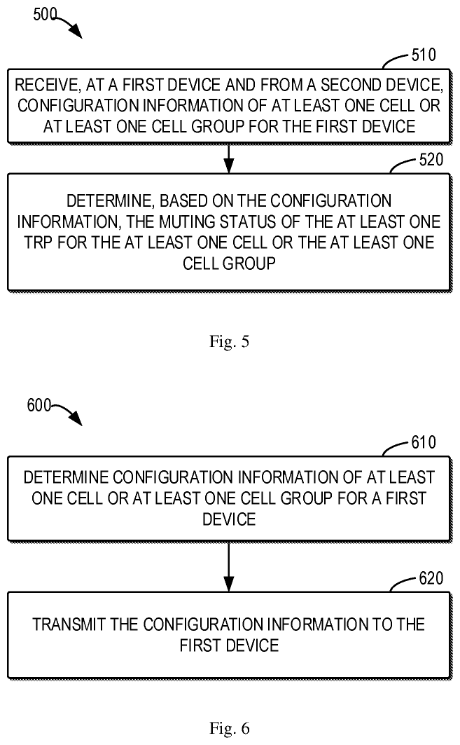

FIG. 5 shows a flowchart of an example method 500 implemented at a terminal device in accordance with some embodiments of the present disclosure. For the purpose of discussion, the method 500 will be described from the perspective of the first device 201 with reference to FIG. 2.

At block 510, the first device 201 receives, from a second device 202, configuration information 210 of at least one cell or at least one cell group for the first device 201, the configuration information indicating muting status of at least one transmission reception point (TRP) for the at least one cell or the at least one cell group. At block 520, the first device 201 determines, based on the configuration information 210, the muting status of the at least one TRP for the at least one cell or the at least one cell group.

In some embodiments, the configuration information further indicates at least one of: bandwidth part (BWP) dormancy information for the first device, or wake-up information for the first device.

In some embodiments, when receiving the configuration information, the first device 201 may determine that the configuration information is received from the second device based on at least one of: a dedicated radio network temporary identifier (RNTI) scrambling downlink control information (DCI), a dedicated control resource set (CORESET) used to send a physical downlink control channel (PDCCH) carrying a DCI, a dedicated field or bit in a DCI or a medium access control (MAC) control element (CE), a dedicated DCI format, or a bitmap indicating the configuration information.

In some embodiments, when receiving the configuration information, the first device 201 may receive, the configuration information via at least one of a user equipment (UE)-specific DCI, a group common DCI, a MAC CE or an RRC.

In some embodiments, when receiving the configuration information, the first device 201 may receive a bitmap in which at least one bit is associated with one of the at least one cell or one of the at least cell group.

In some embodiments, a primary TRP and a secondary TRP are configured for a cell of the at least one cell or the at least one cell group, and the at least one bit comprises a bit indicating the muting status of the secondary TRP for the cell without a bit indicating the muting status of the primary TRP for the cell.

In some embodiments, the at least one bit comprises a first bit and a second bit, and wherein the first bit indicates the muting status of a first TRP for a cell group of the at least one cell group and the second bit indicates the muting status of a second TRP for the cell group.

In some embodiments, in receiving the configuration information, the first device 201 may receive an indicator via at least one of a MAC CE or a DCI, the indicator being associated with a muting pattern of a plurality of muting patterns configured for the first device, the muting pattern indicating the muting status of the at least one TRP for one of the at least one cell or one of the at least one cell group.

In some embodiments, in determining, based on the configuration information, the muting status of the at least one TRP, the first device 201 may determine, for a TRP of the at least one TRP, one of the following status as the muting status: first status in which all transmissions and receptions between the first device and the TRP are muted, second status in which at least one predetermined transmission or reception between the first device and the TRP is muted, and third status in which no transmission or reception between the first device and the TRP is muted.

In some embodiments, a TRP of the at least one TRP is identified or represented (or even replaced by) by at least one of: a CORESETPoolIndex, an identity of a TRP, a set of reference signals (RSs) or a set of RS resources, or a physical cell ID (PCI).

In some embodiments, when receiving the configuration information, the first device 201 may receive a group common DCI containing the configuration information, wherein the group common DCI is destined to a group of devices comprising the first device, and wherein the muting status of one or more TRPs for another device of the group of devices is indicated by the same configuration information or other configuration information contained in the group common DCI.

In some embodiments, when determining, based on the configuration information, the muting status of the at least one TRP, the first device 201 may determine, for a TRP of the at least one TRP, the muting status for a BWP of a cell configured with the TRP.

In some embodiments, one of the at least one cell group is the same as a cell group configured for BWP dormancy or cell dormancy.

In some embodiments, a periodicity of a predetermined transmission or reception in the second status is different from a corresponding periodicity of the predetermined transmission or reception in the third status.

In some embodiments, the muting pattern further indicates at least one of: a muting cycle or muting time-period for one or more TRPs, or an unmuting cycle or muting time-period for one or more TRPs.

In some embodiments, when receiving the configuration information, the first device 201 may receive an indication or a configuration form the second device; and determine, based on the indication or the configuration, that the configuration information is received.

FIG. 6 shows a flowchart of an example method 600 implemented at a network device in accordance with some embodiments of the present disclosure. For the purpose of discussion, the method 600 will be described from the perspective of the second device 202 with reference to FIG. 2.

At block 610, the second device 202 determines configuration information of at least one cell or at least one cell group for a first device, the configuration information indicating muting status of at least one transmission reception point (TRP) for the at least one cell or the at least one cell group. At block 620, the second device 202 transmits the configuration information to the first device.

In some embodiments, the configuration information further indicates at least one of: bandwidth part (BWP) dormancy information for the first device, or wake-up information for the first device.

In some embodiments, in transmitting the configuration information, the second device 202 may transmit, the configuration information via at least one of a user equipment (UE)-specific DCI, a group common DCI, a MAC CE or an RRC.

In some embodiments, in transmitting the configuration information, the second device 202 may transmit a bitmap in which at least one bit is associated with one of the at least one cell or one of the at least one cell group.

In some embodiments, a primary TRP and a secondary TRP are configured for a cell of the at least one cell or the at least one cell group, and the at least one bit comprises a bit indicating the muting status of the secondary TRP for the cell without a bit indicating the muting status of the primary TRP for the cell.

In some embodiments, the at least one bit comprise a first bit and a second bit, wherein the first bit indicates the muting status of a first TRP for a cell group of the at least one cell group and the second bit indicates the muting status of a second TRP for the cell group.

In some embodiments, in transmitting the configuration information, the second device 202 may transmit an indicator via at least one of a MAC CE or a DCI, the indicator being associated with a muting pattern of a plurality of muting patterns configured for the first device, the muting pattern indicating the muting status of the at least one TRP for one of the at least one cell or one of the at least one cell group.

In some embodiments, the at least one TRP comprises a TRP and the muting status of the TRP comprises one of: first status in which all transmissions and receptions between the first device and the TRP are muted, second status in which at least one predetermined transmission or reception between the first device and the TRP is muted, or third status in which no transmission or reception between the first device and the TRP is muted.

In some embodiments, a TRP of the at least one TRP is identified by at least one of: a CORESETPoolIndex, an identity of a TRP, a set of reference signals (RSs) or a set of RS resources, or a physical cell ID (PCI).

In some embodiments, in transmitting the configuration information, the second device 202 may transmit a group common DCI containing the configuration information to a group of devices comprising the first device, and wherein the muting status of one or more TRPs for another device of the group of devices is indicated by the same configuration information or other configuration information contained in the group common DCI.

In some embodiments, the muting status of a TRP of the at least one TRP is associated with a BWP of a cell configured with the TRP.

In some embodiments, one of the at least one cell group is the same as a cell group configured for BWP dormancy or cell dormancy.

In some embodiments, a periodicity of a predetermined transmission or reception in the second status is different from a corresponding periodicity of the predetermined transmission or reception in the third status.

In some embodiments, the muting pattern further indicates at least one of: a muting cycle for one or more TRPs, or an unmuting cycle for one or more TRPs.

In some embodiments, the second device 202 may further transmit an indication or a configuration to the first device 201. The indication or the configuration may indicate that the configuration information indicating the muting status is transmitted. The first device 201 may determine, based on the indication or the configuration, that the configuration information is received.

In some embodiments, an apparatus capable of performing any of the method 500 (for example, the first device 201) may comprise means for performing the respective steps of the method 500. The means may be implemented in any suitable form. For example, the means may be implemented in a circuitry or software module.

In some embodiments, the configuration information further indicates at least one of: bandwidth part (BWP) dormancy information for the first device, or wake-up information for the first device.

In some embodiments, a TRP of the at least one TRP is identified by at least one of: a CORESETPoolIndex, an identity of a TRP, a set of reference signals (RSs) or a set of RS resources, or a physical cell ID (PCI).

In some embodiments, the means for receiving the configuration information may comprise means for determining that the configuration information is received from the second device based on at least one of: a dedicated radio network temporary identifier (RNTI) scrambling downlink control information (DCI), a dedicated control resource set (CORESET) used to send a physical downlink control channel (PDCCH) carrying a DCI, a dedicated field or bit in a DCI or a medium access control (MAC) control element (CE), a dedicated DCI format, or a bitmap indicating the configuration information.

In some embodiments, the means for receiving the configuration information may comprise means for receiving, the configuration information via at least one of a user equipment (UE)-specific DCI, a group common DCI or a MAC CE.

In some embodiments, the means for receiving the configuration information may comprise means for receiving a bitmap in which at least one bit is associated with one of the at least one cell or one of the at least cell group.

In some embodiments, a primary TRP and a secondary TRP are configured for a cell of the at least one cell or the at least one cell group, and wherein the at least one bit comprises a bit indicating the muting status of the secondary TRP for the cell without a bit indicating the muting status of the primary TRP for the cell.

In some embodiments, the at least one bit comprises a first bit and a second bit, and wherein the first bit indicates the muting status of a first TRP for a cell group of the at least one cell group and the second bit indicates the muting status of a second TRP for the cell group.

In some embodiments, the means for receiving the configuration information may comprise means for receiving an indicator via at least one of a MAC CE or a DCI, the indicator being associated with a muting pattern of a plurality of muting patterns configured for the first device, the muting pattern indicating the muting status of the at least one TRP for one of the at least one cell or one of the at least one cell group.

In some embodiments, the means for determining, based on the configuration information, the muting status of the at least one TRP may comprise means for determining, for a TRP of the at least one TRP, one of the following status as the muting status: first status in which all transmissions and receptions between the first device and the TRP are muted, second status in which at least one predetermined transmission or reception between the first device and the TRP is muted, and third status in which no transmission or reception between the first device and the TRP is muted.

In some embodiments, the means for receiving the configuration information may comprise means for receiving a group common DCI containing the configuration information, wherein the group common DCI is destined to a group of devices comprising the first device, and wherein the muting status of one or more TRPs for another device of the group of devices is indicated by the same configuration information or other configuration information contained in the group common DCI.

In some embodiments, the means for determining, based on the configuration information, the muting status of the at least one TRP may comprise means for determining, for a TRP of the at least one TRP, the muting status for a BWP of a cell configured with the TRP.

In some embodiments, the means for receiving the configuration information may comprise: means for receiving an indication or a configuration from the second device; and means for determining, based on the indication or the configuration that the configuration information is received.

In some embodiments, one of the at least one cell group is the same as a cell group configured for BWP dormancy or cell dormancy.

In some embodiments, a periodicity of a predetermined transmission or reception in the second status is different from a corresponding periodicity of the predetermined transmission or reception in the third status.

In some embodiments, the muting pattern further indicates at least one of: a muting cycle or muting time-period for one or more TRPs, or an unmuting cycle or muting time-period for one or more TRPs.

In some embodiments, the apparatus further comprises means for performing other steps in some embodiments of the method 500. In some embodiments, the means comprises at least one processor; and at least one memory including computer program code, the at least one memory and computer program code configured to, with the at least one processor, cause the performance of the apparatus.

In some embodiments, an apparatus capable of performing any of the method 600 (for example, the second device 202) may comprise means for performing the respective steps of the method 600. The means may be implemented in any suitable form. For example, the means may be implemented in a circuitry or software module.

In some embodiments, the apparatus comprises: means for determining configuration information of at least one cell or at least one cell group for a first device, the configuration information indicating muting status of at least one transmission reception point (TRP) for the at least one cell or the at least one cell group; and means for transmitting the configuration information to the first device.

In some embodiments, the configuration information further indicates at least one of: bandwidth part (BWP) dormancy information for the first device, or wake-up information for the first device.

In some embodiments, the means for transmitting the configuration information may comprise means for transmitting, the configuration information via at least one of a user equipment (UE)-specific DCI, a group common DCI, a MAC CE or an RRC.

In some embodiments, the means for transmitting the configuration information may comprise means for transmitting a bitmap in which at least one bit is associated with one of the at least one cell or one of the at least one cell group.

In some embodiments, a primary TRP and a secondary TRP are configured for a cell of the at least one cell or the at least one cell group, and wherein the at least one bit comprises a bit indicating the muting status of the secondary TRP for the cell without a bit indicating the muting status of the primary TRP for the cell.

In some embodiments, the at least one bit comprise a first bit and a second bit, wherein the first bit indicates the muting status of a first TRP for a cell group of the at least one cell group and the second bit indicates the muting status of a second TRP for the cell group.

In some embodiments, the means for transmitting the configuration information may comprise means for transmitting an indicator via at least one of a MAC CE or a DCI, the indicator being associated with a muting pattern of a plurality of muting patterns configured for the first device, the muting pattern indicating the muting status of the at least one TRP for one of the at least one cell or one of the at least one cell group.

In some embodiments, the means for transmitting the configuration information may comprise means for transmitting a group common DCI containing the configuration information to a group of devices comprising the first device, and wherein the muting status of one or more TRPs for another device of the group of devices is indicated by the same configuration information or other configuration information contained in the group common DCI.

In some embodiments, the at least one TRP comprises a TRP and the muting status of the TRP comprises one of: first status in which all transmissions and receptions between the first device and the TRP are muted, second status in which at least one predetermined transmission or reception between the first device and the TRP is muted, or third status in which no transmission or reception between the first device and the TRP is muted.

In some embodiments, a TRP of the at least one TRP is identified by at least one of: a CORESETPoolIndex, an identity of a TRP, a set of reference signals (RSs) or a set of RS resources, or a physical cell ID (PCI).

In some embodiments, the muting status of a TRP of the at least one TRP is associated with a BWP of a cell configured with the TRP.

In some embodiments, one of the at least one cell group is the same as a cell group configured for BWP dormancy or cell dormancy.

In some embodiments, a periodicity of a predetermined transmission or reception in the second status is different from a corresponding periodicity of the predetermined transmission or reception in the third status.

In some embodiments, the muting pattern further indicates at least one of: a muting cycle for one or more TRPs, or an unmuting cycle for one or more TRPs.

In some embodiments, the apparatus further comprises means for transmitting an indication or a configuration to the first device 201. The indication or the configuration may indicate that the configuration information indicating the muting status is transmitted. The first device 201 may determine, based on the indication or the configuration, that the configuration information is received.

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

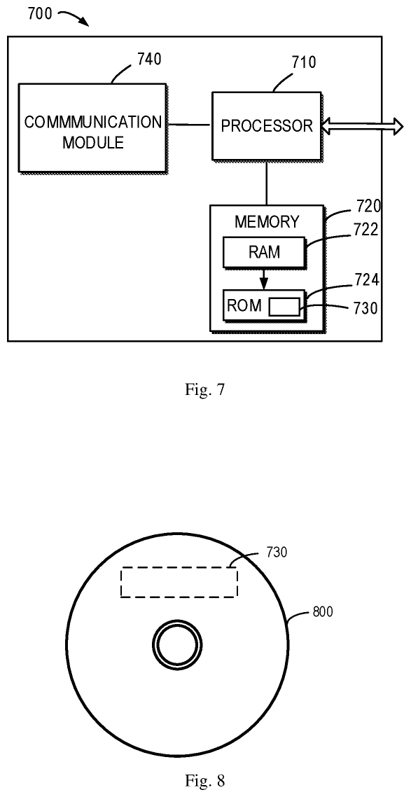

FIG. 7 is a simplified block diagram of a device 700 that is suitable for implementing embodiments of the present disclosure. The device 700 may be provided to implement the communication device, for example the terminal device 120, the terminal device 121, the network device 111 or the network device 112 as shown in FIG. 1. As shown, the device 700 includes one or more processors 710, one or more memories 740 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 500 as described above with reference to FIGS. 2-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-35. (canceled)

36. A first device, comprising:
at least one processor; and
at least one memory storing instructions that, when executed by the at least one processor, cause the first device at least to:
receive, from a second device, configuration information of at least one cell or at least one cell group for the first device, the configuration information indicating muting status of at least one transmission reception point (TRP) for the at least one cell or the at least one cell group; and
determine, based on the configuration information, the muting status of the at least one TRP for the at least one cell or the at least one cell group.

37. The first device of claim 36, wherein the configuration information further indicates at least one of:
bandwidth part (BWP) dormancy information for the first device, or
wake-up information for the first device.

38. The first device of claim 36, wherein the first device is caused to receive the configuration information by:
receiving, the configuration information via at least one of a user equipment (UE)-specific downlink control information (DCI), a group common DCI, a medium access control control element (MAC CE) or a radio resource control (RRC).

39. The first device of claim 36, wherein the first device is caused to receive the configuration information by:
determining that the configuration information is received from the second device based on at least one of:
a dedicated radio network temporary identifier (RNTI) scrambling a DCI,
a dedicated control resource set (CORESET) used to send a physical downlink control channel (PDCCH) carrying a DCI,
a dedicated field or bit in a DCI or a MAC CE,
a dedicated DCI format, or
a bitmap indicating the configuration information.

40. The first device of claim 36, wherein the first device is caused to receive the configuration information by:
receiving a bitmap in which at least one bit is associated with one of the at least one cell or one of the at least cell group.

41. The first device of claim 40, wherein a primary TRP and a secondary TRP are configured for a cell of the at least one cell or the at least one cell group, and wherein the at least one bit comprises a bit indicating the muting status of the secondary TRP for the cell without a bit indicating the muting status of the primary TRP for the cell.

42. The first device of claim 40, wherein the at least one bit comprises a first bit and a second bit, and wherein the first bit indicates the muting status of a first TRP for a cell group of the at least one cell group and the second bit indicates the muting status of a second TRP for the cell group.

43. The first device of claim 36, wherein the first device is caused to receive the configuration information by:
receiving an indicator via at least one of a MAC CE or a DCI, the indicator being associated with a muting pattern of a plurality of muting patterns configured for the first device, the muting pattern indicating the muting status of the at least one TRP for one of the at least one cell or one of the at least one cell group.

44. The first device of claim 36, wherein the first device is caused to determine, based on the configuration information, the muting status of the at least one TRP by:
determining, for a TRP of the at least one TRP, one of the following status as the muting status:
first status in which all transmissions and receptions between the first device and the TRP are muted,
second status in which at least one predetermined transmission or reception between the first device and the TRP is muted, and
third status in which no transmission or reception between the first device and the TRP is muted.

45. The first device of claim 36, wherein a TRP of the at least one TRP is identified by at least one of:
a CORESETPoolIndex,
an identity of a TRP,
a set of reference signals (RSs) or a set of RS resources, or
a physical cell ID (PCI).

46. The first device of claim 36, wherein the first device is caused to receive the configuration information by:
receiving a group common DCI containing the configuration information, wherein the group common DCI is destined to a group of devices comprising the first device, and wherein the muting status of one or more TRPs for another device of the group of devices is indicated by the same configuration information or other configuration information contained in the group common DCI.

47. The first device of claim 36, wherein the first device is caused to determine, based on the configuration information, the muting status of the at least one TRP by:
determining, for a TRP of the at least one TRP, the muting status for a BWP of a cell configured with the TRP.

48. The first device of claim 36, wherein one of the at least one cell group is the same as a cell group configured for BWP dormancy or cell dormancy.

49. The first device of claim 44, wherein a periodicity of a predetermined transmission or reception in the second status is different from a corresponding periodicity of the predetermined transmission or reception in the third status.

50. The first device of claim 43, wherein the muting pattern further indicates at least one of:
a muting cycle or muting time-period for one or more TRPs, or
an unmuting cycle or muting time-period for one or more TRPs.

51. The first device of claim 36, wherein the first device is caused to receive the configuration information by:
receiving an indication or a configuration from the second device; and
determining, based on the indication or the configuration that the configuration information is received.

52. A second device, comprising:
at least one processor; and
at least one memory storing instructions that, when executed by the at least one processor, cause the second device at least to:
determine configuration information of at least one cell or at least one cell group for a first device, the configuration information indicating muting status of at least one transmission reception point (TRP) for the at least one cell or the at least one cell group; and
transmit the configuration information to the first device.

53. The second device of claim 52, wherein the second device is caused to transmit the configuration information by:
transmitting a bitmap in which at least one bit is associated with one of the at least one cell or one of the at least one cell group.

54. The second device of claim 52, wherein the second device is caused to transmit the configuration information by:
transmitting an indicator via at least one of a MAC CE or a DCI, the indicator being associated with a muting pattern of a plurality of muting patterns configured for the first device, the muting pattern indicating the muting status of the at least one TRP for one of the at least one cell or one of the at least one cell group.

55. A method, comprising:
receiving, at a first device and from a second device, configuration information of at least one cell or at least one cell group for the first device, the configuration information indicating muting status of at least one transmission reception point (TRP) for the at least one cell or the at least one cell group; and
determining, based on the configuration information, the muting status of the at least one TRP for the at least one cell or the at least one cell group.
